(19) United States
(12) Patent Application Publication
(10) Pub. No.: US 2017/0120683 A1
(43) Pub. Date: May 4, 2017

(54) PNEUMATIC TIRE

(71) Applicant: TOYO TIRE & RUBBER CO., LTD., Osaka (JP)

(72) Inventor: Yoshiki Sato, Osaka-shi (JP)

(73) Assignee: TOYO TIRE & RUBBER CO., LTD., Osaka (JP)

(21) Appl. No.: 15/294,009

(22) Filed: Oct. 14, 2016

(30) Foreign Application Priority Data
Oct. 30, 2015 (JP) 2015-214917

(51) Int. Cl. B60C 11/03; B60C 11/12

(52) U.S. Cl. CPC B60C 11/0302; B60C 11/1236; B60C 11/0304; B60C 11/0306; B60C 2011/0341; B60C 2011/0374

(57) ABSTRACT

A tread portion of a pneumatic tire has a main groove continuously extending in a tire circumferential direction, a sub main groove extending sideward from a center side in a tire width direction, and a communicating portion making the main groove and the sub main groove communicate with each other. The communicating portion is formed such that a section area of the communicating portion is gradually decreased as the communicating portion extends toward the main groove from the sub main groove.

### CROSS-REFERENCE TO RELATED APPLICATIONS

This application claims priority of Japanese Patent Application No.: 2015-214917 filed on Oct. 30, 2015, the content of which is incorporated herein by reference.

### BACKGROUND OF THE INVENTION

Technical Field

The present invention relates to a pneumatic tire.

Related Art

Conventionally, as the configuration of a pneumatic tire, there has been known the configuration where a pair of left and right circumferential main grooves extending straight along a tire circumferential direction on both sides of a tread center and a plurality of inclined main grooves inclined to one side in the tire circumferential direction from the tread center to the circumferential main grooves are formed on a tread surface, and the inclined main grooves are alternately arranged along the tire circumferential direction on both sides of the tread center (see JP-A-2002-316515, for example).

### SUMMARY

However, JP-A-2002-316515 merely discloses the configuration where only an opening portion of the inclined main groove leading to the circumferential main groove is narrowed, and JP-A-2002-316515 neither discloses nor suggests enhancement of the drain property and the configuration for acquiring the enhancement of drain property.

Further, in the conventional pneumatic tire, a size of a land portion becomes large-sized in the tread center where the inclined main grooves are formed between the circumferential main grooves. In this case, heat is liable to be generated in the land portion, and there is a concern that so-called blowout (breakage of tire) occurs due to such heat. That is, the conventional pneumatic tire has a drawback with respect to endurance at a high speed.

It is an object of the present invention to provide a pneumatic tire which exhibits excellent endurance at a high speed by allowing the pneumatic tire to exhibit favorable heat radiation property by suppressing the generation of heat while allowing the pneumatic tire to maintain proper drain property.

An aspect of the present invention provides a pneumatic tire comprising: a tread portion; a main groove formed on the tread portion and continuously extending in a tire circumferential direction; a sub main groove formed on the tread portion and extending sideward from a center side in a tire width direction; and a communicating portion formed on the tread portion and making the main groove and the sub main groove communicate with each other, wherein the communicating portion is formed such that a section area of the communicating portion is gradually decreased as the communicating portion extends toward the main groove from the sub main groove.

With such a configuration, a speed of drain water which passes through the communicating portion can be increased and hence, the flow of drain water in the main groove can be made smooth.

It is preferable that a triangular portion formed by the communicating portion and the main groove has a first inclined surface which forms a part of the communicating portion, and a second inclined surface which forms a part of the main groove.

With such a configuration, a surface area of the triangular portion can be increased while increasing rigidity of the triangular portion. As a result, heat radiation property at the triangular portion can be enhanced and hence, endurance of the tire at a high speed can be enhanced.

It is preferable that a direction along which the sub main groove extends and a direction along which the communicating portion extends intersect with each other.

It is preferable that the communicating portion makes the sub main groove and the main groove communicate with each other at two positions, and thereby a land portion surrounded by the sub main groove, the main groove, and the communicating portion is formed.

With such a configuration, the land portion can be formed on a more center side in the tire width direction than the main groove. Accordingly, with the provision of the sub main groove, not only a rib which is continuously formed in the tire circumferential direction, but also a plurality of independent land portions can be formed whereby it is possible to further enhance endurance of the tire at a high speed by increasing heat radiation property while suppressing the generation of heat.

It is preferable that the land portion has a tapered portion extending from the sub main groove and having a width and a depth which are gradually decreased in a direction away from the sub main groove.

With such a configuration, heat radiation property can be enhanced by increasing a surface area of the land portion while increasing rigidity of the land portion.

It is preferable that the tapered portion includes a first tapered portion and a second tapered portion, and that the first tapered portion and the second tapered portion communicate with each other through a groove portion having a tapered surface.

With such a configuration, it is possible to further enhance heat radiation property while maintaining rigidity of the land portion.

It is preferable that the land portion includes a sipe which divides the land portion in a tire circumferential direction.

With such a configuration, it is possible to suppress the generation of a pattern noise without lowering rigidity of the land portion.

According to the present invention, the section area of the communicating portion which connects the main groove and the sub main groove to each other is gradually decreased in a direction from the sub main groove to the main groove and hence, drain property can be enhanced by increasing a flow speed of drain water flown into the main groove from the communicating portion.

### BRIEF DESCRIPTION OF THE DRAWINGS

The foregoing and the other features of the present invention will become apparent from the following description and drawings of an illustrative embodiment of the invention in which:

FIG. 1 is a development view showing a tread portion of a pneumatic tire according to an embodiment of the present invention; and

FIG. 2 is partial enlarged perspective view of FIG. 1.

### DETAILED DESCRIPTION OF EMBODIMENTS

Hereinafter, an embodiment of the present invention is described with reference to the attached drawings. The description made hereinafter is provided substantially for merely exemplifying the present invention, and the description does not intend to limit the present invention, a product to which the present invention is applied or applications of the present invention.

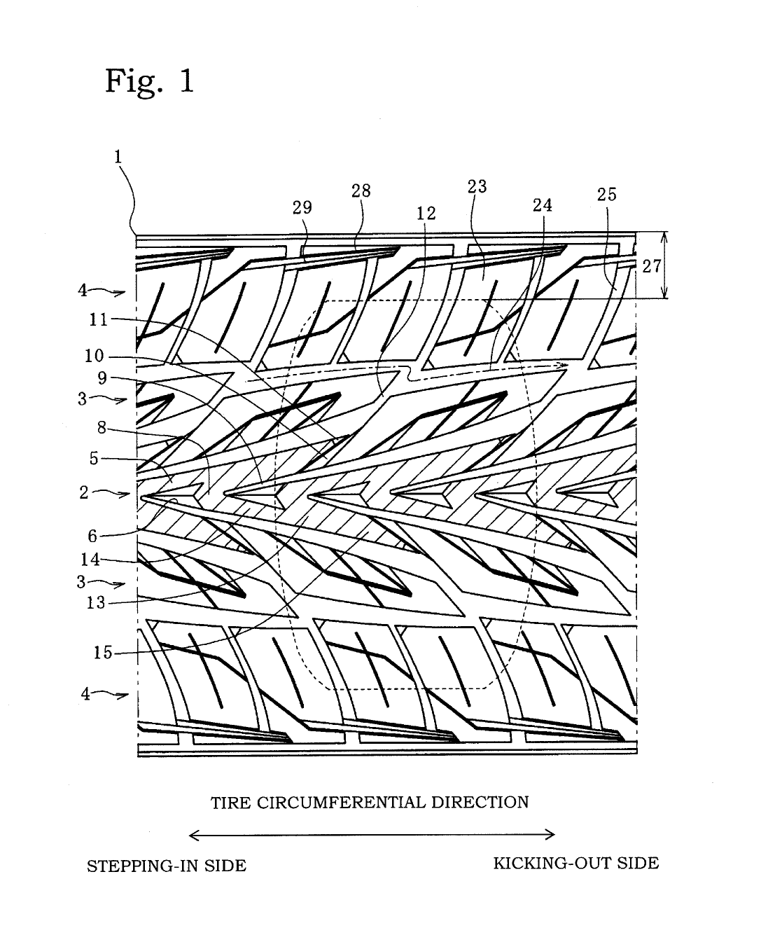

FIG. 1 is a developed view showing a tread portion 1 of a pneumatic tire according to this embodiment. Although not shown in the drawing, the pneumatic tire is configured such that a carcass is extended between a pair of bead cores, an intermediate portion of the carcass is reinforced by a belt wound around an outer peripheral side of the intermediate portion of the carcass, and the pneumatic tire has the tread portion 1 outside the carcass in the tire radial direction. The tread portion 1 is formed of: a center region 2 which is formed at a center portion of the tread portion 1 in the tire width direction; mediate regions 3 disposed on both sides of the center region 2; and shoulder regions 4 disposed on both sides of the tread portion 1.

A rib 5 (indicated by a solid hatched lines in FIG. 1) continuously extending in the tire circumferential direction is formed at the center region 2. A plurality of recessed portions 6 are formed in the rib 5 at predetermined intervals along the tire circumferential direction. Each recessed portion 6 is, as viewed in a developed view, formed into an arrowhead shape where a width of the recessed portion 6 is gradually increased toward the other end (kicking-out) side of the recessed portion 6 from an apex of the recessed portion 6 on one end (stepping-in) side in the tire circumferential direction.

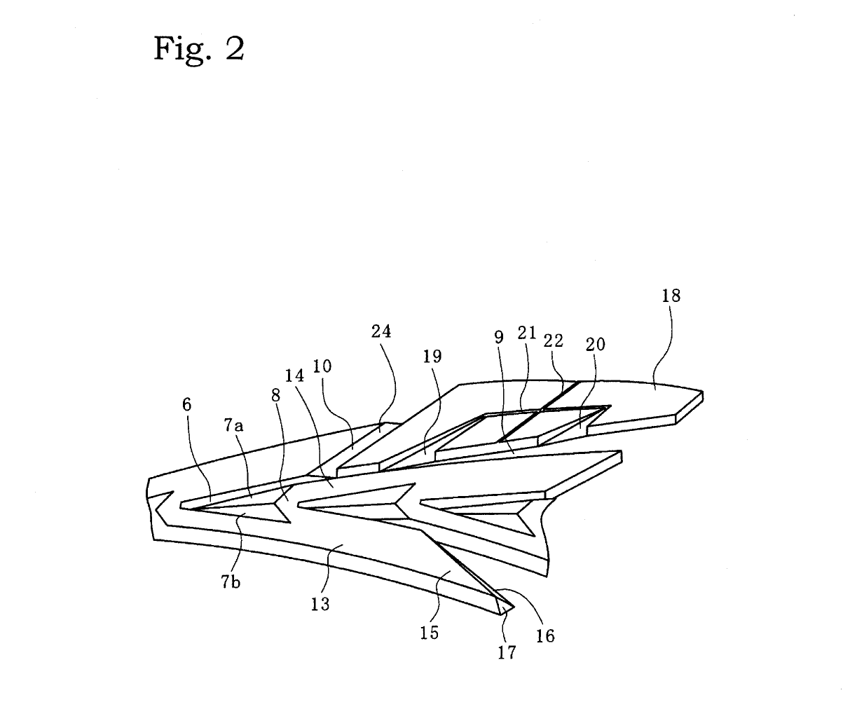

With reference to also FIG. 2, a bottom surface of the recessed portion 6 is formed of inclined surfaces 7a, 7b disposed on both sides with a center line of the tire interposed therebetween. Portions corresponding to a hypotenuses of the inclined surfaces 7a, 7b (inclined portion) have a largest width, and the center line gradually approaches the tread surface as the center line extends toward the kicking-out side of the recessed portion 6. With such a configuration, water recovered to the recessed portions 6 can be drained in such a manner that water is smoothly distributed to left and right sides by the pair of inclined surfaces 7a, 7b.

Opening end edge portions of the recessed portion 6 on the kicking-out side gradually extend in the tire width direction respectively from the center line toward the kicking-out side in the tire circumferential direction so as to form an approximately V shape. With such a configuration, a distal end portion 8 which is pointed toward an apex side of the neighboring recessed portion 6 in the tire circumferential direction is formed. That is, the distal end portion 8 which increases a width thereof from a stepping-in side to a kicking-out side in the tire circumferential direction is formed. The distal end portion 8 plays a role of enhancing drain property by forcibly dividing water on a road surface in left and right directions at the time when the tire is brought into contact with a road surface.

A groove portion (sub main groove 9) is formed along one inclined portion of each recessed portion 6. The sub main groove 9 extends obliquely toward a kicking-out side in the tire circumferential direction and in the tire width direction while extending beyond the recessed portion 6. The extending direction of the sub main groove 9 from the recessed portion 6 is set just opposite with respect to the tire center line between the recessed portions 6 arranged adjacently to each other in the tire circumferential direction. That is, with respect to the sub main grooves 9 which extend from the respective recessed portions 6 sequentially arranged in a row in the tire circumferential direction, the extending directions of the sub main grooves 9 alternately change between one side (right side) and the other side (left side) in the tire width direction. Further, a width size of each sub main groove 9 is gradually increased in the extending direction of the sub main groove 9. With such a configuration, water which flows into the sub main groove 9 minimally receives a flow resistance so that the water smoothly flows to a kicking-out side from a stepping-in side.

A first lateral groove 10 which extends toward a tire lateral side communicates with each sub main groove 9 in the vicinity of the recessed portion 6, and a terminal end portion of each sub main groove 9 is connected to a main groove 24 described later.

As described later, each first lateral groove 10 is defined by a side surface of the mediate block 18 and a first inclined surface 16 on a rib side. The first lateral groove 10 is formed such that a width size of the first lateral groove 10 is gradually decreased as the first lateral groove 10 extends to a distal end thereof. The first lateral groove 10 communicates with a terminal end part of the sub main groove 9 which is arranged adjacently to the first lateral groove 10 in the circumferential direction through a first narrow width portion 11 having the smallest width size. By forming the first lateral grooves 10 branched from the sub main grooves 9, drain property can be enhanced compared to a case where only the sub main grooves 9 are formed on the tread portion 1. Further, by gradually decreasing a width size of the first lateral groove 10, a flow speed of water when water passes through the first narrow width portion 11 can be increased so that an outflow speed of water to a sub main groove side can be increased. Accordingly, it is possible to allow water to flow into each second lateral groove 25 while compensating for the lowering of a flow speed of water which flows through the sub main groove 9 having a gradually increased width size.

In the same manner as the first lateral groove 10, a width size of a rear end portion of each sub main groove 9 is gradually decreased as the rear end portion of each sub main groove 9 extends toward the distal end thereof. The rear end portion of each sub main groove 9 communicates with the main groove 24 through a second narrow width portion 12 having the smallest width size. By gradually decreasing the width size of the rear end portion of the sub main groove 9, it is possible to allow water to flow into the main groove 24 at a high speed. With such a configuration, drain property can be enhanced by accelerating the flow of water in the main groove 24. Further, the position where the rear end portion of the sub main groove 9 and the main groove 24 communicate with each other and the position where the first lateral groove 10 and the sub main groove 9 communicate with each other are disposed substantially on the same straight line. With such a configuration, drain property can be enhanced by further effectively increasing a flow speed.

In this manner, by forming the recessed portions 6, the sub main grooves 9 and the first lateral grooves 10, the rib 5 includes first inclined rib portions 13 and second inclined rib portions 14 which extend toward both sides. The first inclined rib portion 13 includes a triangular portion 15 which has a distal end thereof pointed in a triangular shape by the first lateral groove 10 and the sub main groove 9. The triangular portion 15 includes: the first inclined surface 16 which forms a part of the first lateral groove 10; and a second inclined surface 17 disposed on a main groove 24 side. With such a configuration, rigidity of each triangular portion 15 can be enhanced.

In the mediate region 3A, a plurality of mediate blocks 18 are arranged in a row in the tire circumferential direction. Each mediate block 18 is defined by the sub main grooves 9, the first lateral grooves 10 and the main groove 24.

A first tapered portion 19 and a second tapered portion 20 branched from the sub main groove 9 are formed in the mediate block 18. The first tapered portion 19 and the second tapered portion 20 are formed such that a width and a depth are gradually decreased in a direction away from the sub main groove 9. Further, the first tapered portion 19 and the second tapered portion 20 are formed such that a length of the first tapered portion 19 and a length of the second tapered portion 20 in the tire width direction are set to 30% or more of a length of the mediate block 18 in the tire width direction, and a distal end of the first tapered portion 19 and a distal end of the second tapered portion 20 terminate in the mediate block 18. By forming the first tapered portion 19 and the second tapered portion 20 in this manner, the generation of heat from the mediate block 18 at the time of traveling can be suppressed by suppressing the increase of a volume of the mediate block 18 while realizing the large-sizing of the mediate block 18. By making the mediate block 18 large-sized, cornering performance (cornering power: CP) of the tire 1 can be enhanced. Further, with the formation of the first tapered portion 19 and the second tapered portion 20, a surface area of the mediate block 18 is increased so that heat radiation property of the tire 1 can be also enhanced.

In the mediate block 18, a distal end of the first tapered portion 19 and a distal end of the second tapered portion 20 are connected to each other through a third tapered portion 21. With the formation of the third tapered portion 21, it is possible to make the minimally generate heat by suppressing a volume of the mediate block 18 while increasing rigidity of the mediate block 18. At the same time, with the formation of the third tapered portion 21, it is also possible to facilitate heat radiation by increasing a surface area of the mediate block 18. That is, endurance of the tire 1 at a high speed can be enhanced.

Further, a sipe 22 is also formed in the mediate block 18 such that the sipe 22 intersects with the second tapered portion 20. In this embodiment, the sipe 22 means a groove having a width size of 1.5 mm or less. The sipe 22 makes the sub main groove 9 and the main groove 24 communicate with each other, and divides the mediate block 18 into two parts in the tire circumferential direction. With the function of the sipe 22, it is possible to suppress the generation of a pattern noise without lowering rigidity of the mediate block 18. That is, in the case where the sipe 22 is not formed in the mediate block 18, although a noise is generated only at the time when an edge of the mediate block 18 on a stepping-in side is brought into contact with a road surface, such a noise is influenced by the whole mediate block 18 thus generating a noise of a low frequency which is uncomfortable for a person. However, with the formation of the sipe 22, the mediate block 18 can be divided into two parts in the tire circumferential direction and hence, a noise generated at the time when the mediate block 18 is brought into contact with a road surface is divided into a plurality of (two) small noises of a relatively high frequency per a block unit. Accordingly, a person who hears the noise does not feel so uncomfortable.

In the shoulder region 4, a plurality of shoulder blocks 23 are arranged in a row in the tire circumferential direction. Each shoulder block 23 is defined by the main groove 24 extending in the tire circumferential direction and having a zigzag shape on both sides, and second lateral grooves 25 which extend in the tire width direction so as to intersect with the main groove 24. A narrow groove 26 extending in the tire width direction is formed in a center portion of a front surface of the shoulder block 23.

In a buttress portion 27 of the shoulder block 23, a circumferential groove 28 is formed such that the circumferential groove 28 extends between and over a pair of second lateral grooves 25 adjacently arranged to each other in the tire circumferential direction and makes such pair of second lateral grooves 25 communicate with each other. In this embodiment, the buttress portion 27 means a region from a ground contact end of the tire to a tire maximum width position. A projecting ridge 29 which projects in a crest shape having a triangular shape in cross section is formed on a bottom surface of each circumferential groove 28. A portion of each projecting ridge 29 positioned on the center line and having the largest height is disposed at the same position as a surface of the buttress portion 27. Further, a boundary portion between a bottom surface and a side surface of the recessed portion 6, and boundary portions between the bottom surface of the recessed portion 6 and the inclined surfaces 7a, 7b of the projecting ridge 29 are chamfered. In this manner, the circumferential groove 28 extends between and over the second lateral grooves 25 adjacently arranged to each other in the tire circumferential direction, and the second lateral grooves 25 adjacently arranged to each other in the tire circumferential direction are connected to each other through the circumferential groove 28 on which the projecting ridge 29 is formed. Accordingly, it is possible to increase rigidity of a portion between the shoulder blocks 23 adjacently arranged to each other in the tire circumferential direction.

The circumferential groove 28 are formed in an inclined manner with respect to the tire circumferential direction. Further, the circumferential grooves 28 are formed such that a width of each circumferential groove 28 is gradually decreased as the circumferential groove 28 extends in the inclined direction. In this manner, the circumferential grooves 28 are not positioned on the same circumference in the tire circumferential direction and hence, it is possible to prevent the stress concentration whereby occurrence of cracks or the like can be prevented.

The circumferential grooves arranged adjacently to each other in the tire circumferential direction are arranged so as not to overlap with each other as viewed in the tire width direction. When the circumferential grooves 28 partially overlap with each other, a change in rigidity is increased. To prevent such a change in rigidity, the circumferential grooves are arranged adjacently to each other in the tire circumferential direction.

When a pneumatic tire provided with the tread portion 1 having the above-mentioned constitution travels a road surface, a range where the tire is brought into contact with a ground at a certain moment is a range surrounded by a dotted line in FIG. 1. That is, a portion of the center region 2, portions of the mediate regions 3 and portions of the shoulder regions 4 fall within the range where the tire is brought into contact with ground. The rib 5 is continuously formed in the center region 2 in the tire circumferential direction. Accordingly, although the rib 5 is configured to include the first inclined rib portions 13 and the second inclined rib portions 14 branched in the left and right directions, the tire 1 has high rigidity, and exhibits favorable road surface followability and favorable braking performance.

Further, the bottom surface of the recessed portion 6 is formed of a pair of inclined surfaces 7 each of which has a depth gradually increased toward a lateral side with respect to the center line of the rib 5 and hence, drain property can be enhanced. Water which enters the center region 2 are made to flow in the left and right directions with certainty by the inclined surfaces 7. Accordingly, it is possible to lead water to the main grooves 24 with certainty by the sub main grooves 9.

### Example

A function evaluation test was made with respect to drain property where a vehicle on which pneumatic tires of a comparison example 1 are mounted and a vehicle on which pneumatic tires of an example 1 are mounted were made to travel on a wet road surface having a water depth of 4 mm. A function evaluation test was made with respect to steering stability where the above-mentioned respective vehicles were made to travel on a dry road surface. A function evaluation was made respect to endurance at a high speed where the above-mentioned tires were mounted on drums having a diameter of 1.7 m, were rotated in a state where an fixed load is applied to the tires, and a rotational speed was increased in a stepwise manner by 10 km/h each time. Then, speeds at which the pneumatic tires were broken down were evaluated using indexes. In all evaluation tests, the result of the evaluation obtained with respect to the tire of the comparison example 1 was set as 100 in terms of index, and the respective functions of the example 1 were evaluated in terms of index. Table 1 shows the evaluation result. A comparison example 1 is a pneumatic tire having a tread pattern according to JP-A-2002-316515. The example 1 is a pneumatic tire having a tread pattern shown in FIG. 1.

TABLE 1

| | Comparison example 1 | Example 1 |
|---|---|---|
| Drain property | 100 | 120 |
| Endurance at high speed | 100 | 120 |

As can be clearly understood from Table 1, both drain property and endurance at a high speed can be improved with the use of the pneumatic tires of the example 1.

The present invention is not limited to the configuration described in the embodiment, and various modifications are conceivable.

In the embodiment, the distal end of the recessed portion 6 is formed into a pointed shape with an acute angle. However, the distal end portion of the recessed portion 6 may be formed into various shapes such as an arcuate shape. In short, it is sufficient that the recessed portion 6 has a shape where a width size is gradually increased toward a kicking-out side from a stepping-in side.

In the embodiment, the configuration is adopted where the sub main grooves 9 alternately extend to a right side and a left side from the respective recessed portions 6 arranged in a row in the tire circumferential direction. However, the configuration may be adopted where the sub main grooves 9 which extend in the same direction are formed in a row. For example, three sub main grooves 9 which extend to a right side are formed continuously in a row and, thereafter, three sub grooves which extend extending toward a left side are formed continuously.

What is claimed is:

1. A pneumatic tire comprising:
a tread portion;
a main groove formed on the tread portion and continuously extending in a tire circumferential direction;
a sub main groove formed on the tread portion and extending sideward from a center side in a tire width direction; and
a communicating portion formed on the tread portion and making the main groove and the sub main groove communicate with each other,
wherein the communicating portion is formed such that a section area of the communicating portion is gradually decreased as the communicating portion extends toward the main groove from the sub main groove.

2. The pneumatic tire according to claim 1, wherein a triangular portion formed by the communicating portion and the main groove has a first inclined surface which forms a part of the communicating portion, and a second inclined surface which forms a part of the main groove.

3. The pneumatic tire according to claim 1, wherein a direction along which the sub main groove extends and a direction along which the communicating portion extends intersect with each other.

4. The pneumatic tire according to claim 1, wherein a triangular portion formed by the communicating portion and the main groove has a first inclined surface which forms a part of the communicating portion, and a second inclined surface which forms a part of the main groove, and
wherein a direction along which the sub main groove extends and a direction along which the communicating portion extends intersect with each other.

5. The pneumatic tire according to claim 1, wherein the communicating portion makes the sub main groove and the main groove communicate with each other at two positions, and thereby a land portion surrounded by the sub main groove, the main groove, and the communicating portion is formed.

6. The pneumatic tire according to claim 1, wherein the land portion has a tapered portion extending from the sub main groove and having a width and a depth which are gradually decreased in a direction away from the sub main groove.

7. The pneumatic tire according to claim 1, wherein the tapered portion includes a first tapered portion and a second tapered portion, and
wherein the first tapered portion and the second tapered portion communicate with each other through a groove portion having a tapered surface.

8. The pneumatic tire according to claim 1, wherein the land portion includes a sipe which divides the land portion in a tire circumferential direction.
